(19) United States
(12) Patent Application Publication
(10) Pub. No.: US 2016/0151947 A1
(43) Pub. Date: Jun. 2, 2016

(54) FOAMING MOLD FOR PRODUCING A PROFILE, METHOD FOR PRODUCING A PROFILE, AND PROFILE

(71) Applicant: HILTI AKTIENGESELLSCHAFT, Schaan (LI)

(72) Inventors: Herbert Muenzenberger, Wiesbaden (DE); Mario Paetow, Igling (DE); Andreas Ober, Kaufering (DE)

(73) Assignee: Hilti Aktiengesellschaft, Schaan (LI)

(21) Appl. No.: 14/905,772

(22) PCT Filed: Jul. 17, 2014
(86) PCT No.: PCT/EP2014/065350

§ 371 Date: Jan. 15, 2016

(30) Foreign Application Priority Data
Jul. 17, 2013 (EP) 13176873.1

(51) Int. Cl. B29C 44/58; E04B 1/68; B29C 67/24

(52) U.S. Cl. CPC B29C 44/58; B29C 67/246; E04B 1/6812; B29K 2075/00

(57) ABSTRACT

A foaming mold for foaming a cord- or strip-like profile for building construction or civil engineering, particularly a fire protection profile, is disclosed. The foaming mold has a mold and a cavity to be foamed designed in the mold, where the cavity essentially constitutes a spiral.

This application claims the priority of International Application No. PCT/EP2014/065350, filed Jul. 17, 2014, and European Patent Document No. 13176873.1, filed Jul. 17, 2013, the disclosures of which are expressly incorporated by reference herein.

### BACKGROUND AND SUMMARY OF THE INVENTION

The invention relates to a foaming mold for foaming a cord- or strip-like profile, a method for producing a cord- or strip-like profile, as well as a profile.

Profiles in building construction or civil engineering are used to seal joints and often serve fire protection purposes. In this case, the profiles are manufactured of an intumescent material so that in the event of fire, they can expand and thereby limit the spread of smoke as well as the supply of oxygen to the fire. Conventionally, the profiles are manufactured in a foaming process, such as the RIM process, in an elongated and thus expensive foaming mold.

The integration of these elongated foaming molds in production facilities is problematic.

The problem of the invention is to provide a method and a means that enable the production of cord- or strip-like profiles to be easily integrated in conventional production facilities.

This problem is solved by a foaming mold for foaming a cord- or strip-like profile for building construction or civil engineering, particularly a fire protection joint profile, with a cavity to be foamed designed in the foaming mold, wherein the cavity essentially constitutes a spiral. By producing a profile in the shape of a spiral, the length of the foaming mold no longer corresponds to the length of the profile to be produced; instead, it is much less. The mold is thus also more economical.

Preferably, the radially adjacent sections of the cavity are connected to each other by means of a thin member so that a connection bridge can form at the profile.

The length of the spiral is not limited.

The problem is further solved by a method for producing a cord- or strip-like profile for building construction and civil engineering, particularly by a round cord, a joint profile, or a strip material, wherein a flowable foaming material is introduced into a foaming mold according to the invention, cures in the foaming mold, and is subsequently removed from the foaming mold.

Preferably, the flowable foaming material is a reaction mass that contains at least two components so that a reaction of the two components effects the foaming up of the flowable foaming material.

The flowable foaming material may be polyurethane foam or silicone foam. Due to the prevalence and the low costs of these materials, a profile made of these materials is cost-effective.

In a design variant, the flowable foaming material in a hardened state is an elastically deformable polymer foam, so that the profile can be easily unrolled out of its spiral shape.

In one embodiment of the invention, the flowable material in the hardened state is intumescent, whereby the profiles can be used for fire protection.

In one design variant, the profile consists of a foamable binding agent that contains an intumescent substance mixture. The binding agent thereby serves as a compound-forming carrier for the intumescent substance mixture. Preferably, the substance mixture is distributed homogeneously in the binding agent. The compound-forming carrier is preferably selected from the group consisting of polyurethanes, phenol resins, polystyrenes, polyolefins, such as polyethylene and/or polybutylene, melamine resins, melamine resin foams, synthetic or natural rubber, cellulose, elastomers, and blends thereof, wherein polyurethanes are preferred.

The ash-forming—and if applicable intumescent—substance mixture includes the conventional fire protection additives known to a person skilled in the art, which in the event of fire, in other words under heat, foam up and thereby form a flame dispersion-preventing foam, such as an intumescent material on the basis of an acid producer, a carbon-supplying compound, and a gas producer. Preferably, the intumescent material includes: as an acid producer a salt or an ester of an inorganic, non-volatile acid selected from sulfuric acid, phosphoric acid, and boric acid; as a carbon-supplying compound a polyhydroxy compound and/or a thermoplastic or thermosetting polymeric resin binding agent; and as a gas producer a chlorinated paraffin, melamine, a melamine compound particularly melamine cyanurate, melamine phosphate, melamine polyphosphate, tris(hydroxyethyl)-cyanurate, cyanamide, dicyanamide, dicyandiamide, biguanidine, and/or a guanidine salt, particularly guanidine phosphate or guanidine sulfate.

The compound-forming carrier can also contain as an ablative additive an inorganic compound, which has water, e.g., as crystal water, firmly embedded in it and does not dry out at temperatures up to 100° C., but does release it starting at 120° C. in the event of fire and can thereby cool temperature-conducting parts, preferably an inorganic hydroxide or hydrate releasing water at the fire temperature or when exposed to flame, particularly aluminum hydroxide, aluminum oxide hydrates, or partially hydrated aluminum hydroxide. However, one can consider other inorganic hydroxides or hydrates releasing water when exposed to flame, as they are described in EP 0 274 068 A2.

Such compounds that can be used as substance mixtures in the fire protection insert according to the invention are known to a person skilled in the art and are disclosed for example in the following publications, which are hereby explicitly referred to: DE 30 25 309 A1, DE 30 41 731 A1, DE 33 02 416 A1, DE 34 11 327 A1, EP 0 043 952 B1, EP 0 051 106 B1, EP 0 061 024 B1, EP 0 116 846 B1, EP 0 158 165 B1, EP 0 274 068 A2, EP 1 347 549 A1, EP 1 641 895 B1, and DE 196 53 503 A1.

Materials that may be used for the purposes according to the invention are known from EP 0061024 A1, EP 0051106 A1, EP 0043952 A1, EP 0158165 A1, EP 0116846 A1, and U.S. Pat. No. 3,396,129 A as well as EP 1347549 A1. The molded objects preferably consist of an intumescence-capable polyurethane foam as it is known from EP 0061024 A1, DE 3025309 A1, DE 3041731 A1, DE 3302416 A, and DE 3411 327 A1.

The invention also relates to a profile for sealing joints in building construction or civil engineering, which is designed as an uncoilable spiral and that has a bending elasticity to bend the profile from the spiral shape into a linear shape. A profile is thereby provided whose production is possible in automated production facilities.

Preferably, the radially adjacent sections of the profile merge together via a destructible connection bridge that ensures the spiral shape, so that simple transportation of the profile is assured. The connection bridge may be continuous along the length of the spiral, or there may be a plurality of spaced-apart bridges.

For example, the profile is a fire protection joint profile, particularly in the form of a round cord profile, a strip profile, or a joint profile, by means of which the profile can be used for fire protection purposes.

Additional features and advantages of the invention emerge from the following description and the attached drawings that are referred to.

### BRIEF DESCRIPTION OF THE DRAWINGS

FIG. 1 depicts a top view over one half of a foaming mold according to the invention,

FIG. 2 depicts a cut through a closed foaming mold according to the invention,

FIG. 3 depicts a section of a profile according to the invention,

FIG. 4 depicts the mold according to the invention and with the profile, of FIG. 3 in a top view, produced using the method according to the invention, and

FIGS. 5a and 5b depict various cross-sectional shapes of the profile according to the invention.

### DETAILED DESCRIPTION OF THE DRAWINGS

FIG. 1 depicts one half of a foaming mold 10. Foaming mold 10 includes a bottom mold 12 and a top mold 14 (not depicted), wherein in FIG. 1 bottom mold 12 is depicted in a top view. Bottom mold 12 has a parting plane 16 that faces top mold 14. In the surface of parting plane 16, there is a recess 18 that describes a spiral.

Top mold 14 of foaming mold 10 has, like bottom mold 12, a recess 20. Recess 20 is on the side of top mold 14 that faces bottom mold 12, i.e., arranged in the parting plane, and is also spiral-shaped. However, the spirals of bottom mold 12 and top mold 14 are mirror-inverted to each other, i.e., they can merge into each other by means of an axial reflection via an axis in the parting plane of the mold sides.

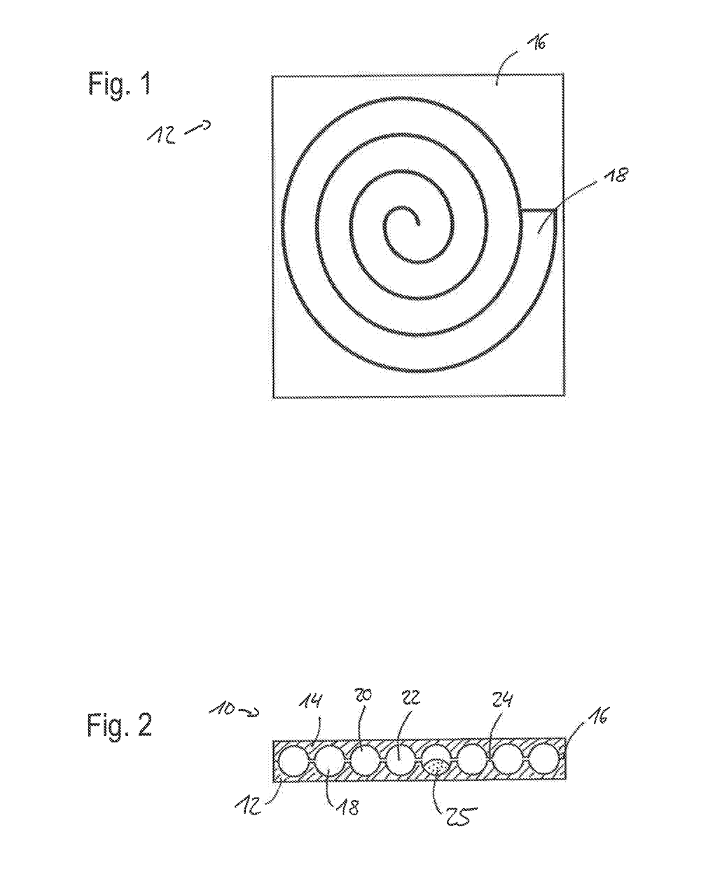

FIG. 2 depicts foaming mold 10 in a closed state. In the closed state, the mold side of top mold 14 lies on the mold side of bottom mold 12 so that recess 18 of bottom mold 12 and recess 20 of top mold 14 are congruent and form cavity 22. Due to the spiral shape of recesses 18 and 20, cavity 22 also forms a spiral. The cross-sectional profile of spiral-shaped cavity 22 is circular, for example; see FIG. 2.

In the regions located between radially adjacent sections of cavity 22, bottom mold 12 and top mold 14 are not in contact so that a thin member 24 forms there. This member 24 thereby connects radially adjacent sections of cavity 22.

The length of spiral-shaped cavity 22, i.e., the length that the cavity 22 would have in the uncoiled shape, is at least 1.5 m.

To produce a cord- or strip-like profile, a flowable foaming material 25, consisting of at least two components, is introduced in recess 18 of bottom mold 12. Flowable foam material 25 is a reaction mass for example and may be polyurethane foam or silicone foam as explained earlier in greater detail.

After filling the flowable material into bottom mold 12 of foaming mold 10, top mold 14 is placed on bottom mold 12 and foaming mold 10 is thereby closed.

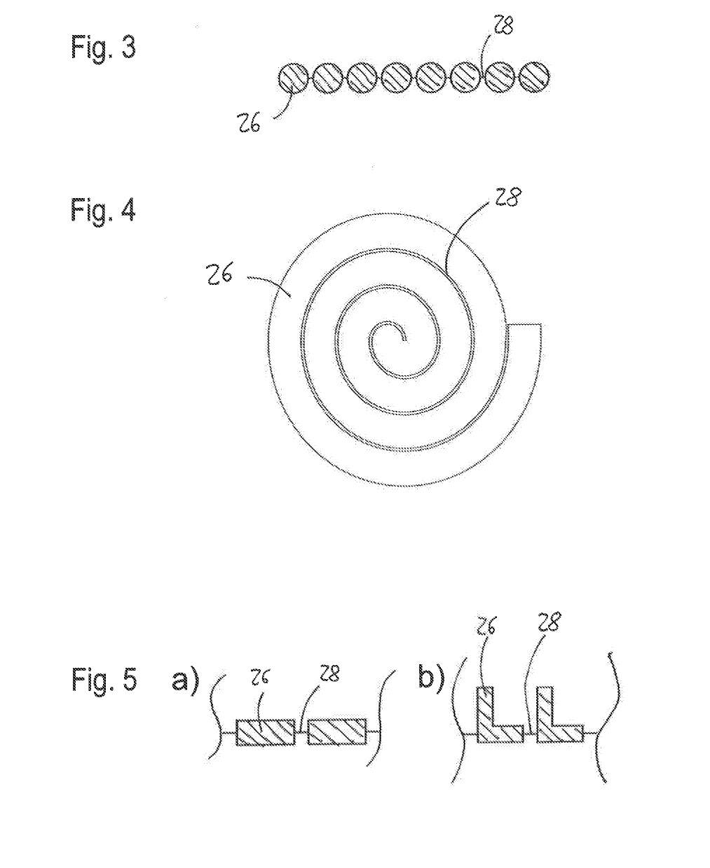

Flowable foaming material 25 now reacts while expanding its volume. Through the volume increase, cured and hardened foaming material 25 fills the entire cavity 22 and member 24, and thereby generates a profile 26 as depicted in FIGS. 3 and 4.

Profile 26, in other words the hardened foaming material, is a deformable polymer foam for example, which may be designed in an intumescent manner if applicable.

Foaming mold 10 is subsequently opened and profile 26 is removed.

Due to the spiral shape of cavity 22, profile 26 depicted in FIGS. 3 and 4 is designed as an uncoilable spiral.

Radially adjacent sections of profile 26 merge together via a destructible connection bridge 28. Connection bridge 28 is created by foaming member 24 and is designed to be so thin that it tears easily without a tool when the spiral is uncoiled.

To use profile 26, it is necessary to uncoil profile 26. To do so, profile 26 has a bending elasticity that enables a user to bend profile 26 out of its spiral shape into a linear shape.

In doing so, connection bridge 28 is at least partially destroyed so that the radially adjacent regions of profile 26 can detach from each other.

For example, profile 26 is a fire protection joint profile, which, as depicted in this embodiment, is a round cord profile.

Other profiles of profile 26 are equally conceivable. As examples, one can mention a strip profile (FIG. 5a) and an L-shaped joint profile (FIG. 5b). Obviously, any other shapes are also conceivable.

It is further noted that the description of foaming mold 10, the method, and profile 26 are in no way to be understood as limiting. For example, providing venting means in foaming mold 10 is advantageous to vent cavity 22 during the foaming of foaming material 25 in cavity 22.

1-10. (canceled)

11. An apparatus for foaming a cord- or strip-like profile for building construction or civil engineering, comprising
a foaming mold, wherein the foaming mold defines a cavity that is fillable with a foam and wherein the cavity essentially constitutes a spiral.

12. The apparatus according to claim 11, wherein a profile formed from the foam in the cavity is a fire protection joint profile.

13. The apparatus according to claim 11, wherein radially adjacent sections of the cavity are connected to each other by a respective thin member.

14. A method for producing a cord- or strip-like profile for building construction or civil engineering, comprising the steps of:
introducing a flowable foaming material into a cavity defined by a foaming mold, wherein the cavity essentially constitutes a spiral;
curing the foaming material in the foaming mold; and
removing the cured foaming material as a profile from the foaming mold.

15. The method according to claim 14, wherein the profile is a round cord, a joint profile, or a strip material.

16. The method according to claim 14, wherein the flowable foaming material is a reaction mass that contains at least two components.

17. The method according to claim 14, wherein the flowable foaming material is a polyurethane foam or a silicone foam.

18. The method according to claim 14, wherein the flowable foaming material is an elastically deformable polymer foam in a hardened state.

19. The method according to claim 14, wherein the flowable foaming material is intumescent in a hardened state.

20. An apparatus for sealing a joint in building construction or civil engineering, comprising:
a profile, wherein the profile is a spiral and wherein the profile has a bending elasticity such that the profile is bendable out of a spiral shape into a linear shape.

21. The apparatus according to claim 20, wherein radially adjacent sections of the profile merge into one another via a destructible connection bridge that maintains the spiral shape.

22. The apparatus according to claim 20, wherein the profile is a fire protection joint profile.

23. The apparatus according to claim 22, wherein the profile has a form of a round cord profile, a strip profile, or a joint profile.
